(19) United States
(12) Patent Application Publication
(10) Pub. No.: US 2016/0187677 A1
(43) Pub. Date: Jun. 30, 2016

(54) RUBBING DEVICE AND RUBBING ALIGNMENT METHOD USING THE SAME

(71) Applicants: BOE TECHNOLOGY GROUP CO., LTD., Beijing (CN); HEFEI XINSHENG OPTOELECTRONICS TECHNOLOGY CO., LTD., Hefei (CN)

(72) Inventors: Xiaofeng WANG, Beijing (CN); Hui JING, Beijing (CN); Zhubing HUANG, Beijing (CN)

(73) Assignees: BOE TECHNOLOGY GROUP CO., LTD., Beijing (CN); HEFEI XINSHENG OPTOELECTRONICS TECHNOLOGY CO., LTD., Hefei (CN)

(21) Appl. No.: 14/796,589

(22) Filed: Jul. 10, 2015

(30) Foreign Application Priority Data
Dec. 24, 2014 (CN) 201410820096.6

(51) Int. Cl. G02F 1/13; G02F 1/1337

(52) U.S. Cl. CPC G02F 1/1303; G02F 1/133784

(57) ABSTRACT

The present disclosure provides a rubbing device and a rubbing alignment method using the rubbing device. The rubbing device includes: a substrate carrying unit including a first table and a second table arranged opposite to each other and configured to secure substrates; a rubbing roller arranged between the first table and the second table; and a first controller configured to control the rubbing roller to be translated relative to the substrate carrying unit in a rotational state, so as to perform a rubbing alignment operation on the substrates carried on the first table and the second table.

### CROSS-REFERENCE TO RELATED APPLICATION

The present disclosure claims a priority of the Chinese patent application No. 201410820096.6 filed on Dec. 24, 2014, which is incorporated herein by reference in its entirety.

### TECHNICAL FIELD

The present disclosure relates to the field of liquid crystal display manufacturing technology, in particular to a rubbing device and a rubbing alignment method using the same.

### BACKGROUND

When manufacturing a display panel using a rubbing process, currently a glass substrate is rubbed by pressing it with a rubbing roller of a mainstream rubbing device through horizontal movement of a single machine table, so as to align an alignment film.

Under the effect of a rotational speed of the rubbing roller, a movement speed of the substrate and parameters of a rubbing cloth, a rubbing alignment operation will not be performed uniformly, which results in uneven brightness of the substrate after a voltage is applied thereto. This uneven brightness is caused by the rubbing process, and it is thus referred to as rubbing Mura. In fact, the continuously occurring rubbing Mura is a main defect for the traditional rubbing process. Currently, the rubbing Mura may be directly prevented by optimizing the process parameters, e.g., by reducing the movement speed of the machine table in a horizontal direction continuously, which however results in a remarkable decrease in the production efficiency.

### SUMMARY

An object of the present disclosure is to provide a rubbing device and a rubbing alignment method using the same, so as to improve the production efficiency.

In one aspect, the present disclosure provides in one embodiment a rubbing device, including: a substrate carrying unit including a first table and a second table arranged opposite to each other and configured to secure substrates; a rubbing roller arranged between the first table and the second table; and a first controller configured to control the rubbing roller to be translated relative to the substrate carrying unit in a rotational state, so as to perform a rubbing alignment operation on the substrates carried on the first table and the second table.

Further, the first controller includes: a first driving mechanism arranged on the rubbing roller or the substrate carrying unit; and a first controlling module configured to control the first driving mechanism, so as to enable the rubbing roller to be translated relative to the substrate carrying unit.

Further, the rubbing device includes a second controller configured to control one of the first table and the second table to move toward the other one of the first table and the second table in accordance with a predetermined press-in amount, so as to adjust a distance between the first table and the second table.

Further, the second controller includes: a second driving mechanism arranged on the substrate carrying unit; and a second controlling module configured to control the second driving mechanism, so as to adjust the distance between the first table and the second table.

Further, the rubbing device includes a support for supporting the rubbing roller.

Further, a rubbing cloth is sleeved onto an outer surface of the rubbing roller.

Further, the first table and the second table secure the substrates via vacuum adsorption, respectively.

In another aspect, the present disclosure provides in one embodiment a rubbing alignment method using the above-mentioned rubbing device, including steps of: securing substrates on a first table and a second table of a substrate carrying unit, respectively; and controlling a rubbing roller to be translated relative to the first table and the second table simultaneously in a rotational state, so as to perform a rubbing alignment operation on the substrates carried on the first table and the second table.

Further, before the controlling a rubbing roller to be translated relative to the first table and the second table simultaneously in a rotational state, the method further includes adjusting a distance between the first table and the rubbing roller in accordance with a predetermined press-in amount of the substrate on the first table, and adjusting a distance between the second table and the rubbing roller in accordance with a predetermined press-in amount of the substrate on the second table.

Further, the predetermined press-in amount of the substrate on the first table is different from the predetermined press-in amount of the substrate on the second table.

Further, the step of securing the substrates on the first table and the second table of the substrate carrying unit, respectively, includes vacuum-adsorbing by the first table the corresponding substrate, and vacuum-adsorbing by the second table the corresponding substrate.

According to the embodiments of the present disclosure, it is able to perform the rubbing alignment operation on the two substrates simultaneously, thereby to improve the production efficiency.

### BRIEF DESCRIPTION OF THE DRAWINGS

FIG. 1 is a schematic view showing a rubbing device according to one embodiment of the present disclosure; and

FIG. 2 is a side view of the rubbing device according to one embodiment of the present disclosure.

### DETAILED DESCRIPTION

The present disclosure will be described hereinafter in conjunction with the drawings and embodiments. The following embodiments are for illustrative purposes only, but shall not be used to limit the scope of the present disclosure.

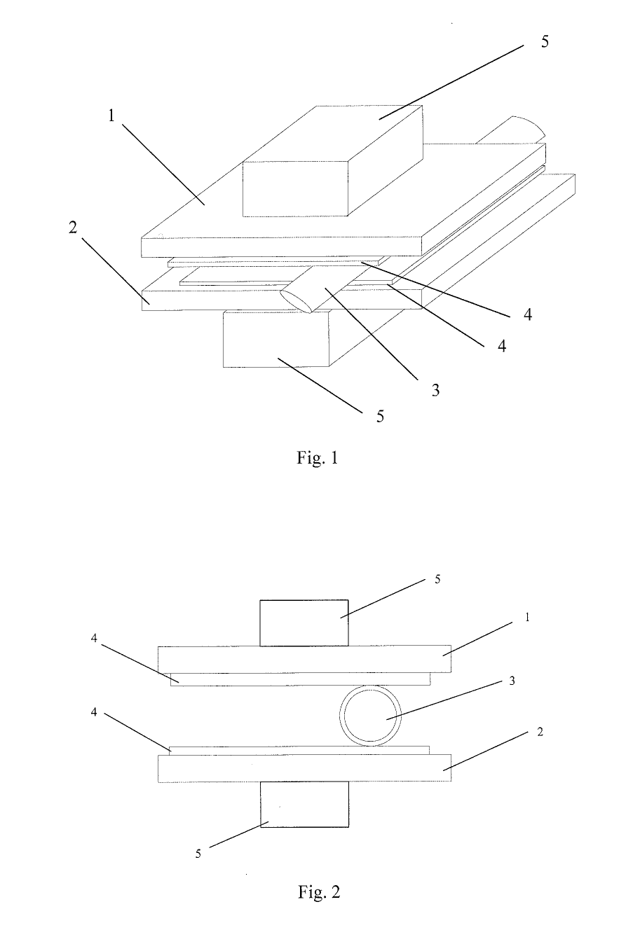

As shown in FIGS. 1-2, the present disclosure provides in one embodiment a rubbing device, which includes: a substrate carrying unit including a first table 1 and a second table 2 arranged opposite to each other and configured to secure substrates 4; a rubbing roller 3 arranged between the first table 1 and the second table 2; and a first controller configured to control the rubbing roller 3 to be translated relative to the substrate carrying unit in a rotational state, so as to perform a rubbing alignment operation on the substrates 4 carried on the first table 1 and the second table 2.

The rubbing roller 3 is arranged between the first table 1 and the second table 2, so as to perform the rubbing alignment operation on the two substrates 4 simultaneously, thereby to improve the production efficiency. In other words, the rubbing roller 3 may perform the rubbing alignment operation on the two substrates located at two sides of the rubbing roller 3 simultaneously, so as to improve the production efficiency.

The first controller may be of various forms, and alternatively, the first controller includes: a first driving mechanism arranged on the rubbing roller or the substrate carrying unit; and a first controlling module configured to control the first driving mechanism, so as to enable the rubbing roller to be translated relative to the substrate carrying unit.

The first driving mechanism is arranged on the rubbing roller and configured to drive the rubbing roller to move under the control of the first controlling module, so as to enable the rubbing roller to be translated relative to the substrate carrying unit. To be specific, the rubbing roller is translated relative to the first table 1, at the same time, the rubbing roller is translated relative to the second table 2, so as to simultaneously perform the rubbing alignment operation by the rubbing roller 3 on the substrates 4 on the first table 1 and the second table 2.

The first driving mechanism may also be arranged on the substrate carrying unit, and specifically on the first table 1 and the second table 2. Under the control of the first controlling module, the first driving mechanism drives the first table to move, so that the first table 1 is translated relative to the rubbing roller 3. At the same time, under the control of the first controlling module, the first driving mechanism drives the second table 2 to move, so that the second table 2 is translated relative to the rubbing roller 3. As a result, it is able to simultaneously perform the rubbing alignment operation by the rubbing roller 3 on the substrates 4 on the first table 1 and the second table 2.

Alternatively, the rubbing device further includes a second controller configured to control one of the first table 1 and the second table 2 to move toward the other one of the first table 1 and the second table 2 in accordance with a predetermined press-in amount, so as to adjust a distance between the first table 1 and the second table 2.

The movement of the first table and/or the second table may be controlled to adjust the press-in amount caused by the rubbing roller 3, so as to simultaneously perform the rubbing alignment operation on the substrates having different requirements of the press-in amount, thereby to improve the production efficiency.

Further, the second controller includes: a second driving mechanism arranged on the substrate carrying unit; and a second controlling module configured to control the second driving mechanism, so as to adjust the distance between the first table 1 and the second table 2.

The rubbing roller 3 is arranged between the first table 1 and the second table 2, so as to adjust the distance between the first table 1 and the second table 2, thereby to adjust the press-in amount of the substrate 4 caused by the rubbing roller 3. The second driving mechanism is arranged on the substrate carrying unit, and specifically, the second riving mechanism may be arranged on the first table and the second table simultaneously. Under the control of the second controlling module, the second driving mechanism drives the first table 1 to move toward the second table 2, so as to adjust the distance between the first table 1 and the second table 2. Meanwhile, under the control of the second controlling module, the second driving mechanism drives the second table 2 to move toward the first table 1, so as to adjust the distance between the second table 2 and the first table 1. The movement of the first table 1 and the second table 2 may be controlled, respectively, so as to simultaneously perform the rubbing alignment operation on the substrates on the first table 1 and the second table 2 at different press-in amounts.

The second driving mechanism is a lifting cylinder 5. Alternatively, the lifting cylinders 5 may be arranged on the first table 1 and the second table 2, respectively.

In another embodiment, the second driving mechanism is arranged on one of the first table 1 and the second table 2, and on the rubbing roller 3. For example, the second driving mechanism is arranged on the first table 1 and the rubbing roller 3. When adjusting the distance between the first table and the second table, the second driving mechanism drives the rubbing roller to move toward the second table under the control of the second controlling module, until the predetermined press-in amount of the substrate on the second table is met. Then, the second driving mechanism drives the first table to move toward the second table under the control of the second controlling module, until the predetermined press-in amount of the substrate on the first table is met.

Alternatively, the rubbing device further includes a support for supporting the rubbing roller 3.

Alternatively, a rubbing cloth is sleeved onto an outer surface of the rubbing roller 3.

Alternatively, the substrates are secured onto the first table 1 and the second table 2 via, but not limited to, vacuum adsorption, respectively.

The present disclosure further provides in one embodiment a rubbing alignment method using the above-mentioned rubbing device, which includes steps of:

securing the substrates 4 on the first table 1 and the second table 2 of the substrate carrying unit, respectively; and

controlling the rubbing roller 3 in a rotational state to be translated relative to the first table 1 and the second table 2 simultaneously, so as to perform the rubbing alignment operation on the substrates 4 carried on the first table 1 and the second table 2.

A working procedure of the rubbing device will be described hereinafter.

One substrate 4 is secured onto a surface of the first table 1 facing the second table 2, and one substrate 4 is secured onto a surface of the second table 2 facing the first table 1. Next, the rubbing roller 3 is moved to an initial position for the rubbing alignment operation. Then, the first table 1 is controlled to move toward the second table 2 in accordance with the press-in amount of the substrate 4 on the first table 1, and the second table 2 is controlled to move toward the first table 1 in accordance with the press-in amount of the substrate on the second table 2. And then, the rubbing roller 3 is rotated, the first table 1 is translated relative to the rubbing roller 3 and the second table 2 is translated relative to the rubbing roller 3, until the rubbing alignment operation is completed.

The above are merely the preferred embodiments of the present disclosure. It should be appreciated that, a person skilled in the art may make further modifications and improvements without departing from the principle of the present disclosure, and these modifications and improvements shall also fall within the scope of the present disclosure.

What is claimed is:

1. A rubbing device, comprising:
a substrate carrying unit including a first table and a second table arranged opposite to each other and configured to secure substrates;
a rubbing roller arranged between the first table and the second table; and
a first controller configured to control the rubbing roller to be translated relative to the substrate carrying unit in a rotational state, so as to perform a rubbing alignment operation on the substrates carried on the first table and the second table.

2. The rubbing device according to claim 1, wherein the first controller comprises:
a first driving mechanism arranged on the rubbing roller or the substrate carrying unit; and
a first controlling module configured to control the first driving mechanism, so as to enable the rubbing roller to be translated relative to the substrate carrying unit.

3. The rubbing device according to claim 2, further comprising a second controller configured to control one of the first table and the second table to move toward the other one of the first table and the second table in accordance with a predetermined press-in amount, so as to adjust a distance between the first table and the second table.

4. The rubbing device according to claim 3, wherein the second controller comprises:
a second driving mechanism arranged on the substrate carrying unit; and
a second controlling module configured to control the second driving mechanism, so as to adjust the distance between the first table and the second table.

5. The rubbing device according to claim 2, further comprising a support for supporting the rubbing roller.

6. The rubbing device according to claim 2, wherein a rubbing cloth is sleeved onto an outer surface of the rubbing roller.

7. The rubbing device according to claim 2, wherein the first table and the second table secure the substrates via vacuum adsorption, respectively.

8. A rubbing alignment method using the rubbing device according to claim 1, comprising steps of:
securing substrates on a first table and a second table of a substrate carrying unit, respectively; and
controlling a rubbing roller to be translated relative to the first table and the second table simultaneously in a rotational state, so as to perform a rubbing alignment operation on the substrates carried on the first table and the second table.

9. The rubbing alignment method according to claim 8, wherein before the controlling a rubbing roller to be translated relative to the first table and the second table simultaneously in a rotational state, the method further comprises adjusting a distance between the first table and the rubbing roller in accordance with a predetermined press-in amount of the substrate on the first table, and adjusting a distance between the second table and the rubbing roller in accordance with a predetermined press-in amount of the substrate on the second table.

10. The rubbing alignment method according to claim 9, wherein the predetermined press-in amount of the substrate on the first table is different from the predetermined press-in amount of the substrate on the second table.

11. The rubbing alignment method according to claim 8, wherein the step of securing the substrates on the first table and the second table of the substrate carrying unit, respectively, comprises:
vacuum-adsorbing by the first table the corresponding substrate; and
vacuum-adsorbing by the second table the corresponding substrate.
